(19) United States
(12) Patent Application Publication
(10) Pub. No.: US 2010/0078214 A1
(43) Pub. Date: Apr. 1, 2010

(54) WATER STOPPING STRUCTURE OF ELECTRIC WIRE AND MARINE VESSEL PROPULSION DEVICE

(75) Inventors: Shingo IGARASHI, Shizuoka (JP); Yoshihiro MIZUSHIMA, Shizuoka (JP)

Correspondence Address: YAMAHA;C/O KEATING & BENNETT, LLP, 1800 Alexander Bell Drive, SUITE 200, Reston, VA, 20191, US

(73) Assignee: Yamaha Hatsudoki Kabushiki Kaisha, Iwata-shi (JP)

(21) Appl. No.: 12/563,314

(22) Filed: Sep. 21, 2009

(30) Foreign Application Priority Data
Sep. 30, 2008 (JP) 2008-252114

(51) Int. Cl. H02G 15/10

(52) U.S. Cl. 174/75 R

(57) ABSTRACT

A water stopping structure of an electric wire includes a first coated electric wire, a second coated electric wire, a wiring member, and insulation. The first coated electric wire has a first core wire and a first insulating coating arranged to coat the first core wire. The second coated electric wire has a second core wire and a second insulating coating arranged to coat the second core wire. The wiring member has a first terminal to which one end of the first core wire is electrically connected, a second terminal to which one end of the second core wire is electrically connected, and a connection wiring unit arranged to electrically connect the first terminal and the second terminal. The insulation is arranged to seamlessly cover the one end of the first core wire, the end of the first insulating coating positioned near the one end of the first core wire, the one end of the second core wire, the end of the second insulating coating positioned near the one end of the second core wire, and the wiring member.

### BACKGROUND OF THE INVENTION

1. Field of the Invention

The present invention relates to a water stopping structure of an electric wire and a marine vessel propulsion device provided with the same.

2. Description of the Related Art

A water stopping structure of an electric wire (first water stopping structure) according to one related art is described in Japanese Unexamined Patent Application Publication No. 2006-202571. The first water stopping structure is arranged such that moisture penetrated in an insulating coating arranged to coat a core wire does not reach a connector and a forward movement of the moisture is stopped at a certain mid portion of the core wire. More specifically, one portion of the insulating coating is peeled off, and one portion of the core wire is exposed from the insulating coating. Moreover, an exposed portion of the core wire is covered with a film material that does not allow moisture to permeate.

Also, a water stopping structure of an electric wire (second water stopping structure) according to another related art is described in Japanese Published Unexamined Patent Application No. 2007-287647. In the second water stopping structure, one portion of an insulating coating is peeled off and one portion of a core wire is exposed from the insulating coating. Further, a silicon resin is dropped onto an exposed portion of the core wire. Moreover, the exposed portion of the core wire is covered with a heat shrinkable tube including hot melt.

### SUMMARY OF THE INVENTION

The inventors of preferred embodiments of the invention described and claimed in the present application conducted an extensive study and research regarding the design and development of a water stopping structure of an electric wire and a marine vessel propulsion device, and in doing so, discovered and first recognized new unique challenges and problems as described in greater detail below.

More specifically, in the first water stopping structure, the core wire is joined over its length without separation at any point. Therefore, even when the exposed portion of the core wire is covered with a film material, there is a possibility that moisture may pass through the core wire to pass through a space between the film material and the core wire. Therefore, it becomes difficult to reliably prevent the infiltration of moisture (by way of passing through the core wire) to the connector.

Also, in the second water stopping structure, the portion in which the insulating coating is peeled off is covered with a heat shrinkable tube. Therefore, passing through of moisture between the core wire and the film material (heat shrinkable tube) in the second water stopping structure is suppressed more reliably than that in the first water stopping structure. However, also in the second water stopping structure, similar to the first water stopping structure, the core wire is joined over its length without separation at any point. Therefore, there is a possibility that moisture passes through a space between the core wire and the film material. Specifically, when dripping of a silicon resin is insufficient, or when heat shrinkage of a heat shrinkable tube is insufficient, there is a possibility that moisture passes through a space between the core wire and the film material. Therefore, it becomes difficult to reliably prevent the infiltration of moisture (by way of passing through the core wire) to the connector.

Also, in the second water stopping structure, when the core wire is arranged by a plurality of intertwined leads, it is difficult to fully spread the silicon resin to the interior of the core wire. Moreover, in this case, even when the heat shrinkable tube is sufficiently shrunk, it is difficult to block a gap in the interior of the core wire by the heat shrinkable tube. Therefore, there is a possibility that moisture passes through a space between the core wire and the film material (heat shrinkable tube). Therefore, it is difficult to prevent the infiltration of moisture (by way of passing through the core wire) to the connector.

In order to overcome the previously unrecognized and unsolved problems described above, one preferred embodiment of the present invention provides a water stopping structure of an electric wire, including at least one first coated electric wire, at least one second coated electric wire, at least one wiring member, and insulation. The first coated electric wire has a first core wire and a first insulating coating arranged to coat the first core wire. The second coated electric wire has a second core wire and a second insulating coating arranged to coat the second core wire. The wiring member has a first terminal to which one end of the first core wire is electrically connected, a second terminal to which one end of the second core wire is electrically connected, and a connection wiring unit arranged to electrically connect the first terminal and the second terminal. The insulation is arranged to seamlessly cover the one end of the first core wire, the end of the first insulating coating positioned near the one end of the first core wire, the one end of the second core wire, the end of the second insulating coating positioned near the one end of the second core wire, and the wiring member.

According to such an arrangement, the first coated electric wire and the second coated electric wire are electrically connected via the wiring member. That is, the first coated electric wire and the second coated electric wire are electric wires separated from each other, and are electrically connected by the wiring member. Therefore, even when moisture passes through the first core wire or the second core wire to reach the wiring member, a forward movement of the moisture can be stopped by the wiring member. Therefore, for example, even when the moisture that has infiltrated within the first coated electric wire passes within the first coated electric wire to reach the wiring member, the infiltration of this moisture from the wiring member within the second coated electric wire can be prevented. Therefore, the infiltration of the moisture by way of passing through the electric wire into the connector can be reliably prevented.

At least one first coated electric wire may include a plurality of first coated electric wires. At least one second coated electric wire may include a plurality of second coated electric wires to respectively correspond to the plurality of first coated electric wires. At least one wiring member may include a plurality of wiring members. In this case, the plurality of wiring members may be arranged to electrically connect the first and second core wires of a plurality of mutually corresponding pairs of first and second coated electric wires, respectively. The water stopping structure may further include a main body formed of a material containing an insulating material. The main body may be arranged to integrally hold the plurality of wiring members. The insulation may be arranged to seamlessly cover the one end of the first core wire, the end of the first insulating coating positioned near the one end of the first core wire, the one end of the second core wire, the end of the second insulating coating positioned near the one end of the second core wire, the plurality of wiring members, and the main body.

Also, the plurality of wiring members may be arrayed in intervals in a predetermined arraying direction. One ends of the plurality of first core wires may be arrayed in intervals in the arraying direction. One ends of the plurality of second core wires may be arrayed in intervals in the arraying direction.

Also, an adjacent pair of one ends of the first core wires adjacent in the arraying direction may be arranged such that their positions are deviated in a deviated direction that is perpendicular or substantially perpendicular to the arraying direction. An adjacent pair of one ends of the second core wires adjacent in the arraying direction may be arranged such that their positions are deviated in the deviated direction.

Also, the insulation may be formed of a material containing a synthetic resin.

Also, the water stopping structure may also include a connector. The interior of the connector may be sealed. The connector may be arranged to be connectable to an electronic device. The other end of the second core wire may be electrically connected to the interior of the connector.

Also, the first and second core wires may include a plurality of leads, respectively.

Also, a marine vessel propulsion device according to another preferred embodiment of the present invention includes a first coated electric wire, a second coated electric wire, a wiring member, insulation and an electronic device. The first coated electric wire has a first core wire and a first insulating coating arranged to coat the first core wire. The second coated electric wire has a second core wire and a second insulating coating arranged to coat the second core wire. The wiring member has a first terminal to which one end of the first core wire is electrically connected, a second terminal to which one end of the second core wire is electrically connected, and a connection wiring unit arranged to electrically connect the first terminal and the second terminal. The insulation is arranged to seamlessly cover the one end of the first core wire, the end of the first insulating coating positioned near the one end of the first core wire, the one end of the second core wire, the end of the second insulating coating positioned near the one end of the second core wire, and the wiring member. The electronic device is electrically connected to the other end of the second core wire.

Also, the marine vessel propulsion device may further include a connector. The interior of the connector may be sealed. The connector may be arranged to be connectable to the electronic device. The other end of the second core wire may be electrically connected to the interior of the connector.

Also, the first and second core wires may include a plurality of leads, respectively.

Other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a plan view showing a water stopping structure of a wire harness according to a first preferred embodiment of the present invention.

FIG. 2 is a lateral side view showing the water stopping structure of the wire harness according to the first preferred embodiment of the present invention.

FIG. 3 is a plan view showing a state before a substrate of the water stopping structure of the wire harness according to the first preferred embodiment is sealed with insulation.

FIG. 4 is a cross-sectional view taken along a 200-200 line in FIG. 1.

FIG. 5 is a cross-sectional view taken along a 300-300 line in FIG. 1.

FIG. 6 is a cross-sectional view taken along a 400-400 line in FIG. 1.

FIG. 7 is a lateral side view showing an outboard motor provided with a water stopping structure of a wire harness according to a second preferred embodiment of the present invention.

FIG. 8 is a circuit diagram showing an outboard motor provided with the water stopping structure of the wire harness according to the second preferred embodiment of the present invention.

FIG. 9 is a cross-sectional view of a water stopping structure of a wire harness according to a modified example of the first preferred embodiment of the present invention.

### DETAILED DESCRIPTION OF THE PREFERRED EMBODIMENTS

### First Preferred Embodiment

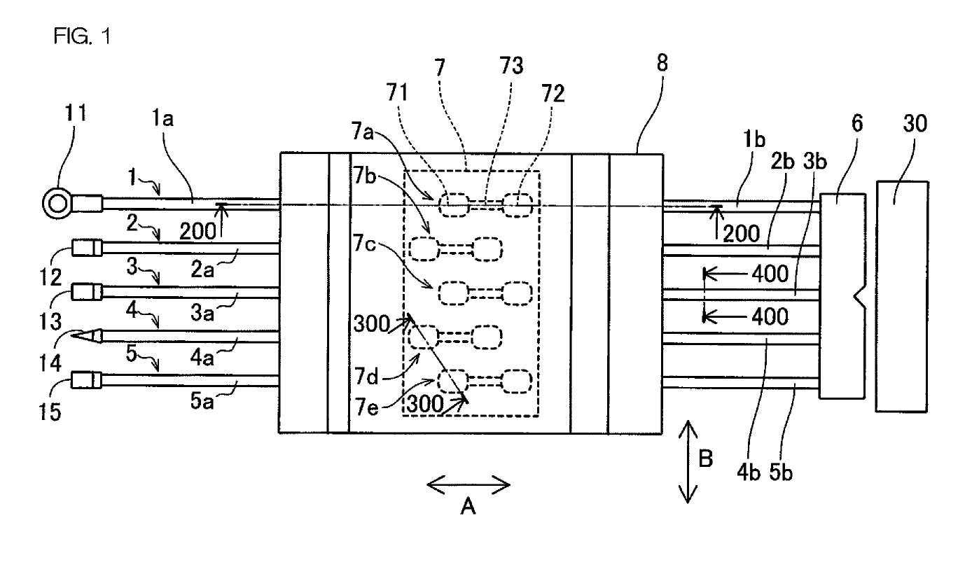

FIG. 1 to FIG. 6 are diagrams for explaining a water stopping structure of a wire harness according to a first preferred embodiment of the present invention. Hereinafter, with reference to FIG. 1 to FIG. 6, the water stopping structure of the wire harness according to the first preferred embodiment of the present invention will be described.

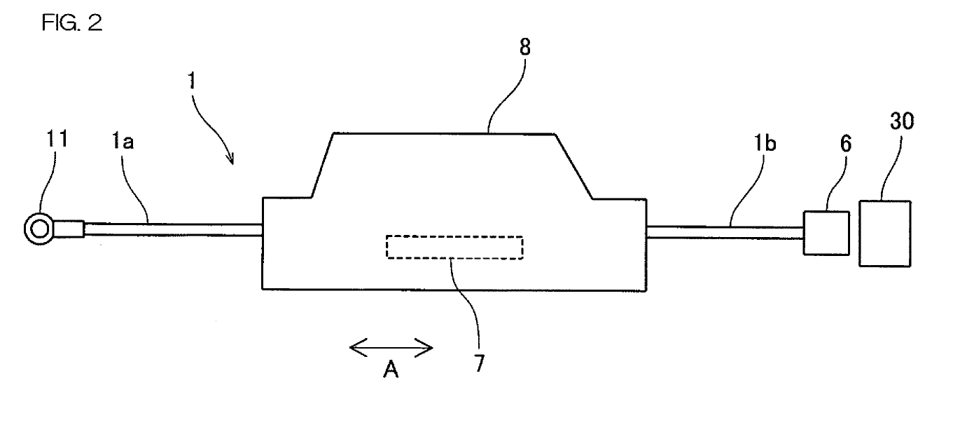

As shown in FIG. 1 and FIG. 2, the wire harness includes five coated electric wires 1, 2, 3, 4, and 5. One ends of the respective coated electric wires 1 to 5 are connected to a waterproof connector 6. When the waterproof connector 6 is connected to an electronic device 30, the respective coated electric wires 1 to 5 and the electronic device 30 are electrically connected.

Also, other ends of the five coated electric wires 1, 2, 3, 4, and 5 are connected to a ground terminal 11, and terminals 12, 13, 14, and 15, respectively. The terminal 12 is one side of a plug and a receptacle with which to form a pair. Likewise, each of the terminals 13, 14, and 15 is one side of a plug and a receptacle with which to form a pair. Although not shown, the terminals 12, 13, 14, and 15 are respectively connected to terminals (plugs or receptacles) with which to form a pair. Moreover, the terminal with which to form a pair with each of the terminals 12, 13, 14, and 15 is connected to another electronic device (not shown).

As shown in FIG. 6, the coated electric wires (coated electric wires 1 to 5) each include a core wire 20 and an insulating coating 21. The core wire 20 may be a strand wire which includes a plurality of intertwined thin leads 20a, for example. The insulating coating 21 coats the circumference of the core wire 20. Although not shown, at a connected portion between the ground terminal 11 and the coated electric wire 1, the insulating coating 21 of the coated electric wire 1 is peeled off. Thereby, at the connected portion between the ground terminal 11 and the coated electric wire 1, the end of the core wire 20 of the coated electric wire 1 is exposed. Likewise, at connected portions between the terminals 12 to 15 and the coated electric wires 2 to 5, the ends of the core wires 20 of the coated electric wires 2 to 5 are exposed from the insulating coatings 21.

Also, the coated electric wires (coated electric wires 1 to 5) are separated in two, for example. The coated electric wire 1 includes a coated electric wire 1a positioned on the ground terminal 11 side and a coated electric wire 1b positioned on the waterproof connector 6 side. Also, the coated electric wires 2, 3, 4, and 5 include coated electric wires 2a, 3a, 4a, and 5a positioned on the terminals 12, 13, 14, and 15 sides, and coated electric wires 2b, 3b, 4b, and 5b positioned on the waterproof connector 6 side.

Each of the coated electric wires 1a, 2a, 3a, 4a, and 5a is one example of a first coated electric wire according to a preferred embodiment of the present invention. Also, each of the coated electric wires 1b, 2b, 3b, 4b, and 5b is one example of a second coated electric wire according to a preferred embodiment of the present invention. The core wire 20 of each of the coated electric wires 1a, 2a, 3a, 4a, and 5a is one example of a first core wire according to a preferred embodiment of the present invention. Also, the insulating coating 21 of each of the coated electric wires 1a, 2a, 3a, 4a, and 5a is one example of a first insulating coating according to a preferred embodiment of the present invention. The core wire 20 of each of the coated electric wires 1b, 2b, 3b, 4b, and 5b is one example of a second core wire according to a preferred embodiment of the present invention. Also, the insulating coating 21 of each coated electric wire 1b, 2b, 3b, 4b, and 5b is one example of a second insulating coating according to a preferred embodiment of the present invention.

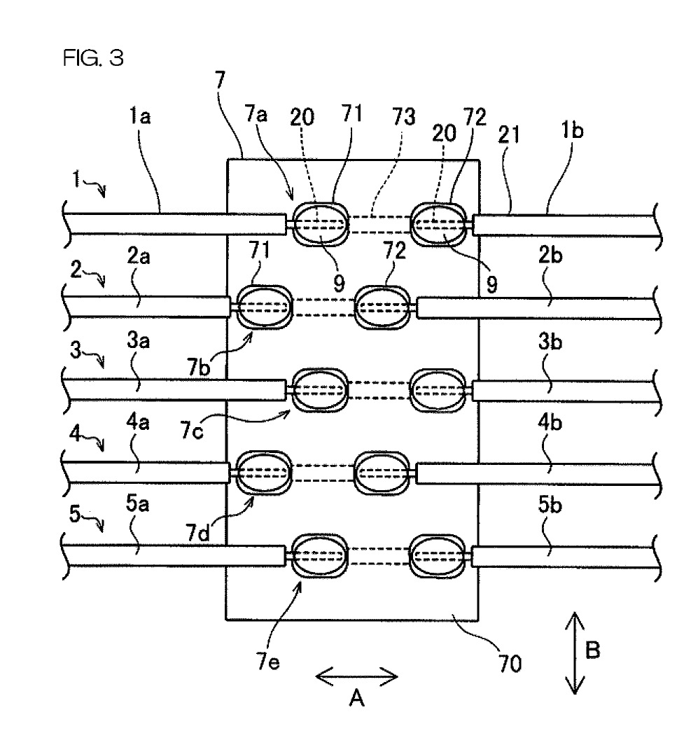

The five coated electric wires 1a to 5a and the coated electric wires 1b to 5b respectively corresponding to these coated electric wires 1a to 5a are electrically connected via the single substrate 7. As shown in FIG. 1 and FIG. 3, the substrate 7 preferably has a plate shape, for example. The substrate 7 includes a main body 70 and wirings 7a, 7b, 7c, 7d, and 7e. The main body 70 is formed of an insulating material, for example. The main body 70 preferably has a plate shape, for example. The wirings 7a, 7b, 7c, 7d, and 7e are each integrally held by the main body 70. The wirings 7a, 7b, 7c, 7d, and 7e correspond to the coated electric wires 1, 2, 3, 4, and 5, respectively. Each of the wirings 7a, 7b, 7c, 7d, and 7e is one example of a wiring member according to a preferred embodiment of the present invention.

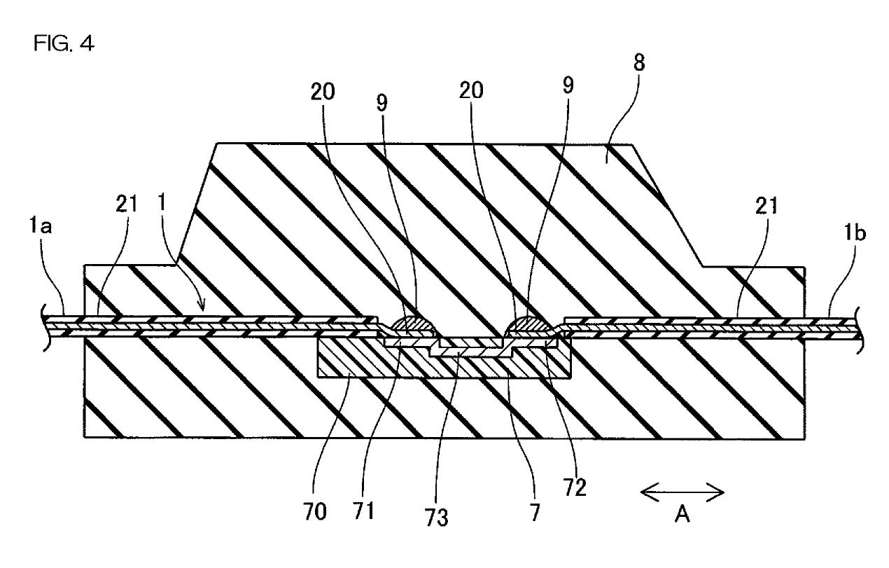

Each of the wirings 7a to 7e includes an electrode 71, an electrode 72, and an electrode connecting unit 73. The electrode 71, the electrode 72, and the electrode connecting unit 73 are one example of a first terminal, a second terminal, and a connection wiring unit according to a preferred embodiment of the present invention, respectively. The electrode 71 and the electrode 72 are each arranged to be partially exposed from the top surface of the main body 70. Also, the electrode connecting unit 73 is arranged not to be exposed from the top surface of the main body 70. More specifically, as shown in FIG. 4, the whole electrode connecting unit 73 is arranged inside the main body 70. The circumference of the electrode connecting unit 73 is seamlessly covered by the main body 70. The electrode connecting unit 73 is preferably formed by a single wiring member, for example.

Also, the electrode 71, the electrode 72, and the electrode connecting unit 73 are arranged to extend in an A direction (deviated direction). As shown in FIG. 1 and FIG. 3, the wirings 7a to 7e are arranged side by side in parallel or substantially in parallel to a B direction (arraying direction) that is perpendicular or substantially perpendicular to the A direction. Also, the wirings 7b and 7d are arranged at a position deviated in the B direction relative to the wirings 7a, 7c, and 7e. Thereby, the electrodes 71 adjacent to each other are arranged at positions mutually deviated in the B direction. Specifically, for example, the electrode 71 of the wiring 7a and the electrode 71 of the wiring 7b are arranged at positions mutually deviated in the B direction. Moreover, the electrodes 72 adjacent to each other (the electrode 72 of the wiring 7a and the electrode 72 of the wiring 7b, for example) are also arranged at positions mutually deviated in the B direction.

As shown in FIG. 3, the coated electric wire 1a and the coated electric wire 1b are electrically connected to the electrode 71 and the electrode 72 of the wiring 7a, respectively. Specifically, the one end of the core wire 20 of the coated electric wire 1a is exposed from the insulating coating 21 at a portion connected with the electrode 71. The one end of the core wire 20 of the coated electric wire 1a is soldered to the electrode 71 by a solder 9. Moreover, the one end of the core wire 20 of the coated electric wire 1b is exposed from the insulating coating 21 at a portion connected with the electrode 72. The one end of the core wire 20 of the coated electric wire 1b is soldered to the electrode 72 by the solder 9. Moreover, the coated electric wires 2a to 5a and the coated electric wires 2b to 5b are soldered to the electrodes 71 and electrodes 72 of the wirings 7b to 7e, respectively, by the solder 9.

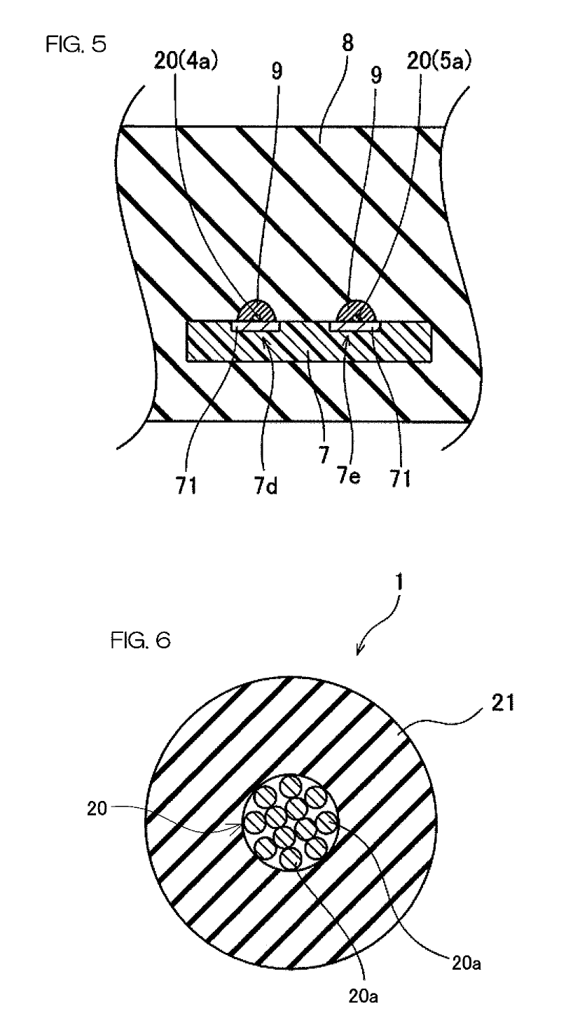

Also, as shown in FIG. 1, FIG. 2, FIG. 4, and FIG. 5, portions of the coated electric wires 1 to 5 and the substrate 7 are covered with a resin 8. More specifically, as described above, the one end of the core wire 20 of the coated electric wire 1a (or the coated electric wires 2a to 5a) is exposed from the insulating coating 21 at the portion connected with the electrode 71. Moreover, the one end of the core wire 20 of the coated electric wire 1b (or the coated electric wires 2b to 5b) is exposed from the insulating coating 21 at the portion connected with the electrode 72. The one end of the core wire 20 of each of the coated electric wires 1a, 2a, 3a, 4a, and 5a and the end of the insulating coating 21 positioned near the one end of the core wire 20 are seamlessly covered with the resin 8. Also, the one end (end on the substrate 7 side) of the core wire 20 of each of the coated electric wires 1b, 2b, 3b, 4b, and 5b and the end of the insulating coating 21 positioned near the one end of the core wire 20 are seamlessly covered with the resin 8. Moreover, the wirings 7a, 7b, 7c, 7d, and 7e, and the main body 70 are seamlessly covered with the resin 8. The resin 8 is one example of insulation according to a preferred embodiment of the present invention.

The interior of the resin 8 is sealed. The one end (end on the substrate 7 side) of each of the coated electric wires 1b to 5b is seamlessly covered with the resin 8. Also, the other end (end opposite the substrate 7) of each of the coated electric wires 1b to 5b is electrically connected to the interior of the waterproof connector 6. The interior of the waterproof connector 6 is a sealed space. The internal space of the insulating coating 21 of each of the coated electric wires 1b to 5b is communicated to the internal space of the waterproof connector 6.

Also, the resin 8 is preferably formed of a material containing a synthetic resin, for example. More specifically, the resin 8 is formed of a synthetic resin, such as hot melt, having an insulating property, for example. As shown in FIG. 4, the resin 8 is arranged between a connected portion between the coated electric wire 1a (or the coated electric wires 2a to 5a) and the electrode 71 and a connected portion between the coated electric wire 1b (or the coated electric wires 2b to 5b) and the electrode 72. The resin 8 is arranged to partition these connected portions.

Also, the resin 8 is arranged between the adjacent connected portions, out of the connected portions between the coated electric wires (coated electric wires 1a to 5a) and the electrodes 71. Also, the resin 8 is arranged to partition these connected portions. More specifically, as shown in FIG. 5, for example, the resin 8 is arranged between the connected portion between the electrode 71 of the wiring 7d and the coated electric wire 4a, and the connected portion between the electrode 71 of the wiring 7e and the coated electric wire 5a. Likewise, the resin 8 is arranged between the adjacent connected portions, out of the connected portions between the coated electric wires (coated electric wires 1b to 5b) and the electrodes 72. Also, the resin 8 is arranged to partition these connected portions.

Next, technical effects and advantages in the water stopping structure according to the first preferred embodiment of the present invention will be illustrated hereinafter.

In the first preferred embodiment, each of the coated electric wires 1 to 5 is preferably separated in two. Further, the separated coated electric wires are electrically connected to one another via the wirings. Therefore, even when the moisture passes through the coated electric wires 1a to 5a to reach the electrode 71, the forward movement of the moisture is stopped by the electrode connecting unit 73. Thereby, it becomes possible to reliably prevent the infiltration of the moisture from the electrode connecting unit 73 to the coated electric wires 1b to 5b sides. Thus, it is possible to reliably prevent the infiltration of the moisture (by way of passing through the coated electric wires 1 to 5) to the waterproof connector 6.

Also, in the first preferred embodiment, the five coated electric wires 1a to 5a and coated electric wires 1b to 5b are electrically connected via the single substrate 7, respectively. Therefore, the infiltration of the moisture to each of the coated electric wires 1b to 5b is reliably prevented by the single substrate 7. Therefore, as compared to a case that the water stopping structure is provided for each of the coated electric wires 1 to 5, the water stopping structure can be simplified. More specifically, there is no need to provide the substrate 7 and the resin 8 for each of the coated electric wires 1 to 5, and thus, the water stopping structure can be simplified while preventing an increase in number of the substrates 7 and the resins 8.

Also, in the first preferred embodiment, the circumference of the electrode connecting unit 73 is seamlessly covered by the main body 70. Therefore, the infiltration of the moisture from the electrode connecting unit 73 to the coated electric wires 1b to 5b sides can be reliably prevented by the main body 70.

Also, in the first preferred embodiment, one end (exposed portions) of the core wire 20 of the coated electric wires 1a to 5a is seamlessly covered with the resin 8. Also, one end (exposed portion) of the core wire 20 of the coated electric wires 1b to 5b is seamlessly covered with the resin 8. Therefore, the infiltration of the moisture from the one end side of the core wire 20 of the coated electric wires 1a to 5a within the insulating coating 21 of the coated electric wires 1a to 5a can be prevented. Likewise, the infiltration of the moisture from the one end side of the core wire 20 of the coated electric wires 1b to 5b within the insulating coating 21 of the coated electric wires 1b to 5b can be prevented. Thereby, even when one portion of the core wire 20 is exposed from the insulating coating 21, the infiltration of the moisture within the coated electric wires 1 to 5 can be prevented.

Also, in the first preferred embodiment, the resin 8 is arranged to cover the whole circumference of the substrate 7. Therefore, a portion exposed from the insulating coating 21 in each core wire 20, together with the substrate 7, is seamlessly covered with the resin 8. Thus, as compared to a case that only a portion exposed from the insulating coating 21 in each core wire 20 is covered with the resin 8, the infiltration of the moisture within the coated electric wires 1 to 5 can be prevented more effectively.

Also, in the first preferred embodiment, the resin 8 is arranged between the connected portion between the coated electric wires 1a to 5a and the electrode 71 and the connected portion between the coated electric wires 1b to 5b and the electrode 72. Therefore, the flowing of the moisture along an external surface of the substrate 7 between the connected portion between the coated electric wires 1a to 5a and the electrode 71 and the connected portion between the coated electric wires 1b to 5b and the electrode 72 can be prevented. Thereby, it becomes possible to prevent the moisture which reaches the connected portion between the coated electric wires 1a to 5a and the electrode 71 from infiltrating within the coated electric wires 1b to 5b after passing through the substrate 7.

Also, in the first preferred embodiment, the resin 8 is arranged between the adjacent connected portions, out of the connected portions between the coated electric wires (coated electric wires 1a to 5a) and the electrode 71. Moreover, the resin 8 is arranged between the adjacent connected portions, out of the connected portions between the coated electric wires (coated electric wires 1b to 5b) and the electrode 72. Therefore, when the moisture has an electric conductivity, mutual electric connections among the adjacent coated electric wires 1a to 5a and those among the adjacent coated electric wires 1b to 5b, which occur via the moisture, can be prevented. Thereby, it becomes possible to prevent the coated electric wires 1a to 5a adjacent to one another or the coated electric wires 1b to 5b adjacent to one another from being mutually short-circuited.

Also, in the first preferred embodiment, the substrate 7 is sealed by the resin 8, and thereby, the substrate 7 can be easily covered.

Also, in the first preferred embodiment, the shape of the substrate 7 is simple, and thus, manufacturing of the substrate 7 is easy. Also, the coated electric wires 1a to 5a and the coated electric wires 1b to 5b may be connected by simply linking each core wire 20 to the substrate 7. Therefore, manufacturing of the water stopping structure according to the first preferred embodiment is easy.

Also, in the first preferred embodiment, the electrodes 71 adjacent to each other and the electrodes 72 adjacent to each other are respectively arranged at a position deviated in the B direction perpendicular or substantially perpendicular to the A direction. Therefore, as compared to a case that the electrodes 71 adjacent to each other and the electrodes 72 adjacent to each other are not arranged to be deviated in the B direction, distances between the electrodes 71 adjacent to each other and those between the electrodes 72 adjacent to each other can be made greater. Thereby, short-circuit of the electrodes 71 to one another due to the moisture can be effectively prevented. Moreover, short-circuit of the electrodes 72 to one another due to the moisture can be effectively prevented.

Also, in the first preferred embodiment, the other end (end opposite to the substrate 7) of each of the coated electric wires 1b to 5b is connected to the waterproof connector 6. Also, as described above, in the water stopping structure according to the first preferred embodiment, the infiltration of the moisture within the coated electric wires 1b to 5b is prevented. Therefore, the infiltration of water from the coated electric wires 1b to 5b sides within the waterproof connector 6 can be prevented. Thus, the generation of short-circuit, caused due to the moisture, within the waterproof connector 6 can be prevented. Thereby, the occurrence of a problem in the electronic device 30, resulting from the generation of short-circuit within the waterproof connector 6, can be prevented.

Also, in the first preferred embodiment, each of the electrode connecting unit 73 is provided by a single wiring member. Therefore, unlike a case that each of the electrode connecting unit 73 is provided by a plurality of wiring members, a water infiltrating channel that passes through the single electrode connecting unit 73 can be limited to one. Therefore, when the single infiltrating channel is all blocked at each of the electrode connecting unit 73, the infiltration of the water from the coated electric wires 1a to 5a to the coated electric wires 1b to 5b can be reliably and easily prevented.

### Second Preferred Embodiment

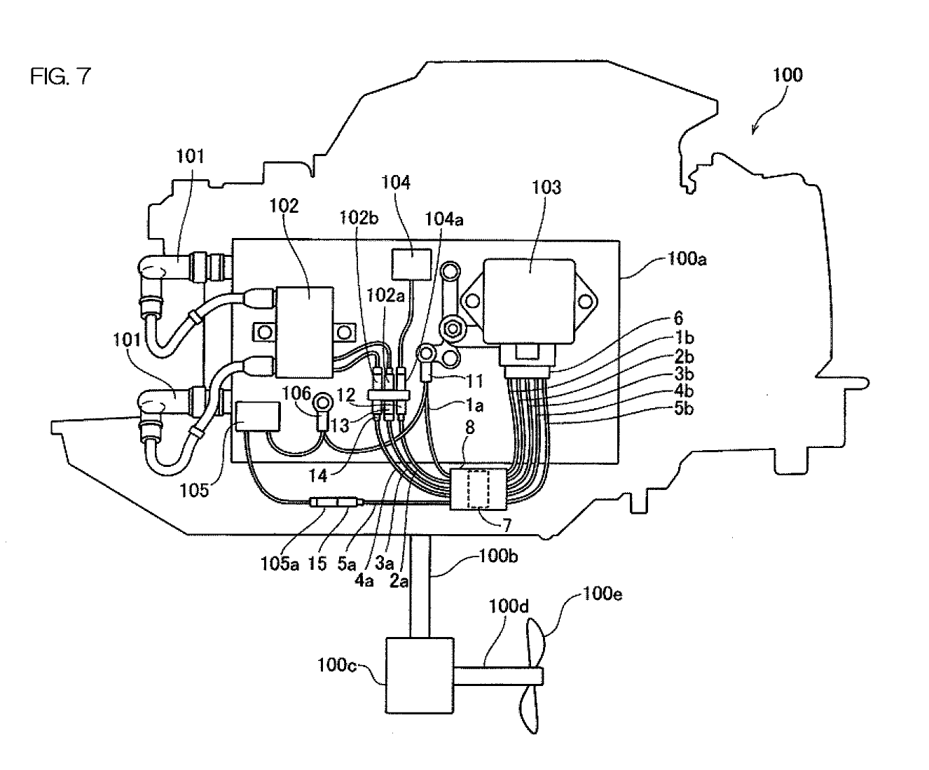

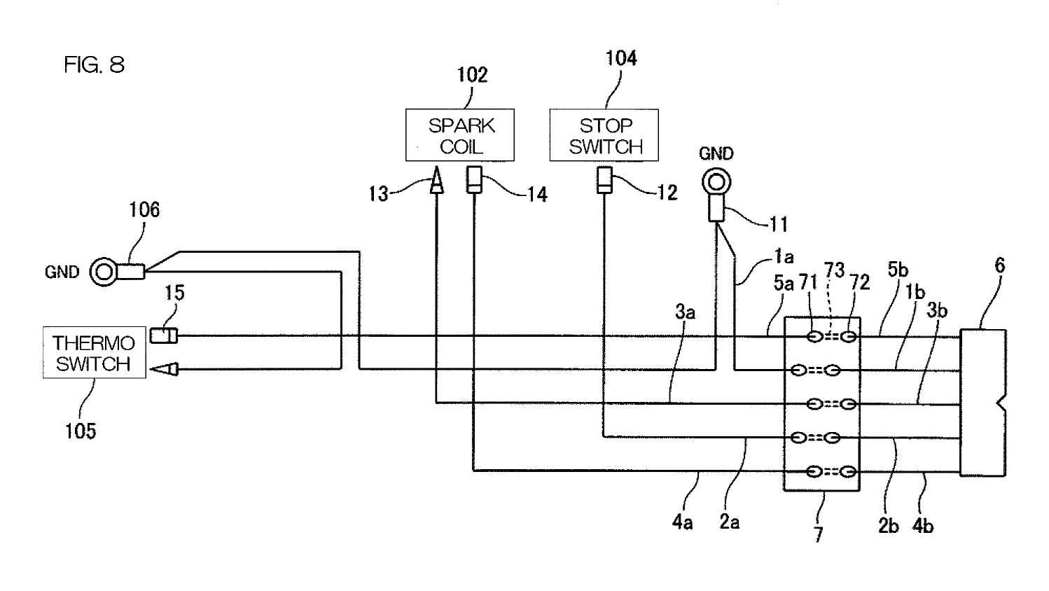

FIG. 7 and FIG. 8 are diagrams for explaining the structure of an outboard motor provided with a water stopping structure of a wire harness according to a second preferred embodiment of the present invention. With reference to FIG. 7 and FIG. 8, the structure of an outboard motor 100 provided with the water stopping structure of the wire harness according to the second preferred embodiment of the present invention will be described below. In the second preferred embodiment, an example in which the present invention is applied to the outboard motor 100, which is one example of a marine vessel propulsion device, will be explained.

The outboard motor 100 is provided with an engine 100a, a drive shaft 100b, a forward-reverse switching mechanism 100d, and a propeller 100e. The drive shaft 100b is arranged such that it is driven by the engine 100a to make rotation. The forward-reverse switching mechanism 100d is arranged to transmit the rotation of the drive shaft 100b to the propeller shaft 100c.

Also, the engine 100a includes a cylinder (not shown) and a CDI unit 103. The CDI unit 103 is one example of an electronic device according to a preferred embodiment of the present invention. The CDI unit 103 controls the operation of the engine 100a, for example. Specifically, the CDI unit 103 controls a spark plug 101 and a spark coil 102, for example. The spark plug 101 is for burning an air fuel mixture within the cylinder.

Also, the CDI unit 103 is electrically connected to a user-operable stop switch 104, a thermo switch 105 arranged to detect a temperature of the engine 100a, a spark coil 102, and the ground terminal 11. The CDI unit 103 controls the spark coil 102 based on a signal from the stop switch 104, a signal from the thermo switch 105, etc.

The water stopping structure according to the first preferred embodiment is applied to a coated electric wire (wire harness) arranged to connect the CDI unit 103, the stop switch 104, the thermo switch 105, the spark coil 102, and the ground terminal 11. That is, the waterproof connector 6 is connected to the CDI unit 103. The ground terminal 11 is fixed to the engine 100a. The terminal 12 is connected to the terminal 104a that is connected to the stop switch 104. The terminals 13 and 14 are connected to the terminals 102a and 102b that are connected to the spark coil 102, respectively. The terminal 15 is connected to the terminal 105a that is connected to the thermo switch 105. The ground terminal 11 is connected to the ground terminal 106 that is connected to the thermo switch 105.

The outboard motor 100 is generally used under a high moisture environment. When the water stopping structure of the wire harness according to the first preferred embodiment is applied to the outboard motor 100 used under such an environment, the generation of a problem of the outboard motor 100, resulting from the infiltration of the moisture, can be prevented. More specifically, even when the moisture passes on from the ground terminal 11 or the terminals 12 to 15 through the coated electric wires 1a to 5a to reach the electrode 71, the forward movement of the moisture can be stopped by the electrode connecting unit 73. Thereby, it becomes possible to prevent the infiltration of the moisture from the electrode connecting unit 73 to the coated electric wires 1b to 5b sides. Therefore, the infiltration of the moisture within the waterproof connector 6 can be reliably prevented. Moreover, reaching of the moisture to the waterproof connector 6 is prevented, and thus, the generation of short-circuit, resulting from the moisture, within the waterproof connector 6 can be prevented. Thereby, the occurrence of a problem in the CDI unit 103, resulting from the generation of short-circuit within the waterproof connector 6, can be prevented.

Also, as described above, the interior of the waterproof connector 6 is sealed. The internal space of the insulating coating 21 of each of the coated electric wires 1b to 5b is communicated to the internal space of the waterproof connector 6. On the other hand, there is a case that the waterproof connector 6 is heated by heat of the engine 100a or by heat of electric conduction, for example. Moreover, there is also a case that the waterproof connector 6 is cooled when it receives a spray when the outboard motor 100 is being operated, for example. Therefore, due to a change in temperature of the waterproof connector 6, the air within the waterproof connector 6 may be expanded or contracted. However, in this case, when the air within the waterproof connector 6 is contracted, a suction force is acted within each of the coated electric wires 1b to 5b. As a result, when the water stopping structure (first and second water stopping structures) according to the foregoing related art is used, for example, there is a possibility that the moisture infiltrates within the waterproof connector 6.

More specifically, in the water stopping structure according to the foregoing related art, the core wire is joined over its length without separation at any point. Therefore, when the suction force is acted within the coated electric wire, there is a possibility that the moisture is suctioned by the suction force from the other end (end opposite to the waterproof connector) of the coated electric wire. Then, the suctioned moisture may pass through the interior of the coated electric wire to reach the waterproof connector. As described above, the outboard motor generally is used under a high moisture environment. As a result, it is highly probable that the other end of the coated electric wire is exposed to water. Thus, it is highly probable that the moisture infiltrates within the coated electric wire from the other end of the coated electric wire.

On the other hand, in the water stopping structure according to the first preferred embodiment, each of the coated wirings 1 to 5 is separated at any midpoint over the length. Therefore, even when the suction force is acted within each of the coated wirings 1 to 5, the suction force is not transmitted to the other end of each of the coated wirings 1 to 5 (the end to which each of the terminals 12 to 15 is connected). Moreover, at any mid portion over its length each of the coated wirings 1 to 5 is seamlessly covered with the resin 8. Therefore, the infiltration of the moisture within each of the coated wirings 1 to 5 from any mid portion of each of the coated wirings 1 to 5 can be prevented. Thereby, the infiltration of the moisture within the waterproof connector 6 can be prevented.

Other effects and advantages of the second preferred embodiment are similar to those of the first preferred embodiment.

The preferred embodiments of the present invention have been described above. The present invention is not limited to the contents of the foregoing preferred embodiments, and can be modified in various ways within the scope of the claims. For example, the first and second preferred embodiments present an example in which the substrate 7 is preferably arranged to perform water stopping of the five coated electric wires 1 to 5. However, the substrate 7 may also be arranged to perform water stopping of a single coated electric wire or a plurality (other than five) of coated electric wires.

Also, the first and second preferred embodiments present an example in which the substrate 7 preferably has a plate shape. However, the substrate 7 may be formed in any shape other than the plate shape.

Also, the first and second preferred embodiments present an example in which the resin 8 is arranged to seal the whole substrate 7. However, the resin 8 may be arranged not to cover the whole substrate 7. Specifically, the resin 8 may be arranged to cover at least a portion exposed from the insulating coating 21 in each core wire 20.

Also, the first and second preferred embodiments present an example in which each core wire 20 is arranged by a plurality of leads 20a. However, the respective core wires 20 may each be arranged by a single lead.

Also, the second preferred embodiment presents an example in which the present invention is applied to the outboard motor 100, which is one example of a marine vessel propulsion device. However, the present invention may be applied to marine vessel propulsion devices other than the outboard motor 100. For example, the present invention may be applied to an inboard motor or an inboard/outboard motor. Moreover, the present invention may be applied to water jet propulsion watercraft provided with an impeller (thrust generating unit) such as Marine Jet (registered trademark).

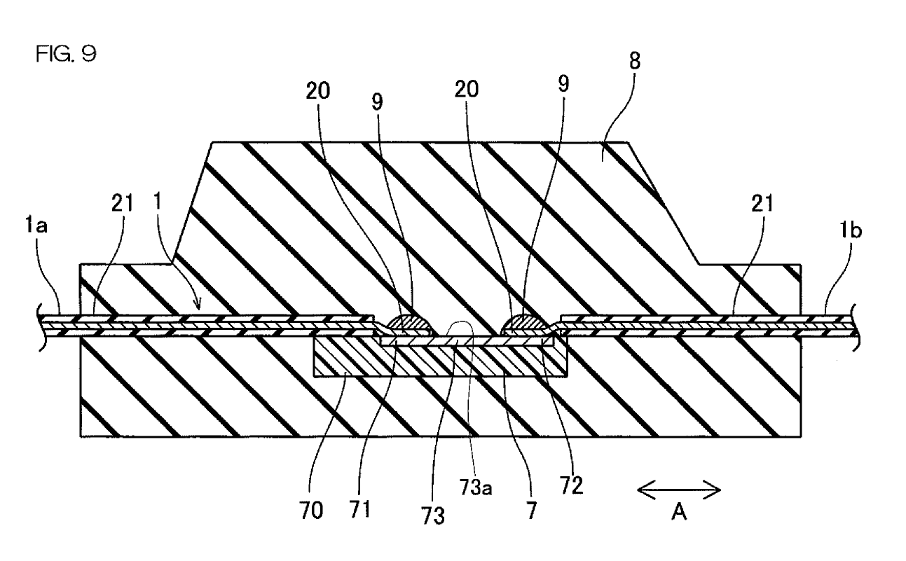

Also, the first and second preferred embodiments present an example in which the electrode connecting unit 73 is arranged so as not to be exposed from the top surface of the main body 70. However, the electrode connecting unit 73 may be arranged to be exposed from the top surface of the main body 70. Specifically, as shown in FIG. 9, for example, it may be arranged such that one top surface 73a of the electrode connecting unit 73 is exposed from the top surface of the main body 70. More specifically, each electrode 71, each electrode 72, and each electrode connecting unit 73 may be a portion of a wiring pattern provided on the top surface of the main body 70, for example. Moreover, a whole of the top surface of the main body 70 and the wiring pattern may be covered with a thin film (resist film, for example). In this case, each electrode 71 and each electrode 72 may be arranged to be exposed from an opening provided on the thin film.

Also, the first and second preferred embodiments present an example in which the first coated electric wires (coated electric wires 1a to 5a), the second coated electric wires (coated electric wires 1b to 5b), and the wiring members (wirings 7a, 7b, 7c, 7d, and 7e) are each provided in plural. However, the respective numbers of first coated electric wires, the second coated electric wires, and the wiring members may be one each.

The present application corresponds to Japanese Patent Application No. 2008-252114 filed in the Japan Patent Office on Sep. 30, 2008, and whole disclosure of this application is incorporated in its entirety herein by reference.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A water stopping structure of an electric wire, comprising:
at least one first coated electric wire having a first core wire and a first insulating coating arranged to coat the first core wire;
at least one second coated electric wire having a second core wire and a second insulating coating arranged to coat the second core wire;
at least one wiring member having a first terminal to which one end of the first core wire is electrically connected, a second terminal to which one end of the second core wire is electrically connected, and a connection wiring unit arranged to electrically connect the first terminal and the second terminal; and
insulation arranged to seamlessly cover the one end of the first core wire, an end of the first insulating coating positioned near the one end of the first core wire, the one end of the second core wire, an end of the second insulating coating positioned near the one end of the second core wire, and the wiring member.

2. The water stopping structure of an electric wire according to claim 1, wherein
the at least one first coated electric wire includes a plurality of first coated electric wires;
the at least one second coated electric wire includes a plurality of second coated electric wires respectively corresponding to the plurality of first coated electric wires;
the at least one wiring member includes a plurality of wiring members arranged to respectively electrically connect the first and second core wires of a plurality of mutually corresponding pairs of the first and second coated electric wires;
the water stopping structure further includes a main body, made of a material containing an insulating material, arranged to integrally hold the plurality of wiring members; and
the insulation is arranged to seamlessly cover the one end of the first core wire, the end of the first insulating coating positioned near the one end of the first core wire, the one end of the second core wire, the end of the second insulating coating positioned near the one end of the second core wire, the plurality of the wiring members, and the main body.

3. The water stopping structure of an electric wire according to claim 2, wherein
the plurality of wiring members are arrayed in intervals in a predetermined arraying direction;
the one ends of the plurality of first core wires are arrayed in intervals in the arraying direction; and
the one ends of the plurality of second core wires are arrayed in intervals in the arraying direction.

4. The water stopping structure of an electric wire according to claim 3, wherein
a pair of the one ends of the first core wires adjacent in the arraying direction are arranged such that their positions are deviated in a deviated direction that is perpendicular or substantially perpendicular to the arraying direction; and
a pair of the one ends of the second core wires adjacent in the arraying direction are arranged such that their positions are deviated in the deviated direction.

5. The water stopping structure of an electric wire according to claim 1, wherein the insulation is made of a material containing a synthetic resin.

6. The water stopping structure of an electric wire according to claim 1, further comprising a connector having a sealed interior and which is arranged to be connected to an electronic device; wherein
the other end of the second core wire is electrically connected to the interior of the connector.

7. The water stopping structure of an electric wire according to claim 1, wherein the first and second core wires include a plurality of leads, respectively.

8. A marine vessel propulsion device comprising:
a first coated electric wire having a first core wire and a first insulating coating arranged to coat the first core wire;
a second coated electric wire having a second core wire and a second insulating coating arranged to coat the second core wire;
a wiring member having a first terminal to which one end of the first core wire is electrically connected, a second terminal to which one end of the second core wire is electrically connected, and a connection wiring unit arranged to electrically connect the first terminal and the second terminal;
insulation arranged to seamlessly cover the one end of the first core wire, an end of the first insulating coating positioned near the one end of the first core wire, the one end of the second core wire, an end of the second insulating coating positioned near the one end of the second core wire, and the wiring member; and
an electronic device to which the other end of the second core wire is electrically connected.

9. The marine vessel propulsion device according to claim 8, further comprising a connector having a sealed interior and which is arranged to be connected to the electronic device; wherein
the other end of the second core wire is electrically connected to the interior of the connector.

10. The marine vessel propulsion device according to claim 8, wherein the first and second core wires include a plurality of leads, respectively.
